(19) United States
(12) Patent Application Publication
(10) Pub. No.: US 2020/0068805 A1
(43) Pub. Date: Mar. 5, 2020

(54) Hay Hugger Apparatus

(71) Applicant: TEXAS TECH UNIVERSITY SYSTEM, Lubbock, TX (US)

(72) Inventors: Jeff Hanson, Lubbock, TX (US); Shalene Smith, Lubbock, TX (US); Michael Arthur, Lubbock, TX (US); Kenneth Cramblitt, Lubbock, TX (US); Dean Fleitman, Lubbock, TX (US)

(21) Appl. No.: 16/529,083

(22) Filed: Aug. 1, 2019

Related U.S. Application Data
(60) Provisional application No. 62/713,062, filed on Aug. 1, 2018.

(51) Int. Cl. A01D 87/00; A01D 87/12

(52) U.S. Cl. CPC A01D 87/003; A01D 87/127

(57) ABSTRACT

A hugger apparatus for lifting a load generally includes a plurality of arms including a first arm and a second arm respectively attached to a first plate and a second plate. An offset hydraulic arrangement is provided, which includes first and second hydraulic bars. The offset hydraulic arrangement connects to and engages the first plate and second plate so as to respectively move the first and second arms into extended or retracted positions for engaging with and lifting and moving a load.

### CROSS REFERENCE TO RELATED PATENT APPLICATION

This patent application claims the priority and benefit, under 35 U.S.C. § 119(e), of U.S. Provisional Patent Application Ser. No. 62/713,062, filed Aug. 1, 2018, which is incorporated herein by reference in its entirety.

### TECHNICAL FIELD

Embodiments are related to the field of lifting machinery, and more particularly to devices configured for lifting and moving of cargo and/or bales of fibrous material such as hay or other items such as boxes, pallets, and so on.

### BACKGROUND

Agriculture and ranching are two of the largest industries in the United States. One problem many farmers and ranchers experience is not having a quick and easy way to move different hay bale sizes without switching machine attachments. A durable attachment is simply not available in the market today that possesses the necessary range to pick up, for example, a single two tie bale and then extend outward sufficiently enough to grab, for example, a 3×4×8 feet cubed grouping of bales. If the farmer does have an attachment to pick up the larger bales, he will be unable to pick up the single bales. Thus, the farmer or user must resort to lifting the bales by hand, which is hard on their backs over time.

One of the difficulties that farmers encounter in loading and unloading bales of hay is the necessity of changing attachments every time the farmer wants to pick up a different sized hay bale. Not only is this a hassle, but it wastes time. A grapple is conventionally used for large groupings of hay bales. A grapple can pick up, for example, 10 bales at a time but it cannot lift a single bale is is extremely dangerous and difficult to maneuver when placing hay into a truck.

Another piece of equipment that farmers may employ is a device referred to as “The Squeeze” by Marquest. Such an apparatus 40 is shown in FIG. 4. When picking up a large group of bales such as the 3×4×8 feet cubed group of bales, the arms of the apparatus 40 shown in FIG. 4 begin to permanently deform, splaying outwards due to pressure, ruining the whole attachment. The prior art apparatus 40 shown in FIG. 4 is unable to pick up, for example, a 2-tie or 3-tie single bale. In addition, apparatus 40 is also poorly welded, causing warm in the arms 42 and 44. The arms 42 and 44 simply cannot compress to the desired length. A need thus exists for an improved attachment for efficiently and safely loading and unloading hay bales, particular of different shapes and sizes.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is therefore one aspect of the disclosed embodiments to provide for an apparatus that engages with and then lifts and moves a load.

It is another aspect of the disclosed embodiments to provide for a hay hugger apparatus that lifts and moves loads such as bales of hay of different sizes and shapes.

It is yet another aspect of the disclosed embodiments to provide for a hay hugger apparatus with a hydraulic arrangement for extending and moving arms that engage with and lift and move a load.

It is also an aspect of the disclosed embodiments to provide for a hugger hugger apparatus as an attachment that connects to lifting machines such as forklifts, skid steers, articulated loaders, tractors, telehandlers and so on.

The aforementioned aspects and other objectives and advantages can now be achieved as described herein. A hugger apparatus for lifting a load is disclosed. The apparatus generally includes a plurality of arms including a first arm and a second arm respectively attached to a first plate and a second plate. An offset hydraulic arrangement is provided, which includes first and second hydraulic bars. The offset hydraulic arrangement connects to and engages the first plate and second plate so as to respectively move the first and second arms into extended or retracted positions for engaging with and lifting and moving a load. The first and second plates respectively comprise arm plates.

The offset hydraulic arrangement generally includes a female boom that maintains the first and second hydraulic bars. An attachment plates connects to the female boom, which allows the hugger apparatus to attach to an external lifting machine such as a forklift, a skid steer, an articulated loader, a tractor, a telehandler and so on.

In addition at least one male boom is provided, which engages the female boom. Each of the first and second arm plates include a respective arm plate gusset. In a preferred embodiment, the aforementioned load comprises a hay bale, but it should be appreciated that the disclosed hugger apparatus can be utilized in applications other than farming scenarios. The hugger apparatus may be utilized in for example, warehouses, grocery stores and so on to engage with and lift and move loads, such as boxes, crates, pallets, and so on.

The aforementioned hugger apparatus is thus a bale squeeze grappling attachment with offset hydraulics set up to lift a variety of bale sizes. The apparatus includes an arm configuration comprising reinforcing gussets that transfer bending momentum away from the arms the arm avoiding deflection.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the disclosed embodiments, serve to explain the principles of the present invention.

FIG. 1(a) illustrates a perspective view of a hay hugger apparatus in a closed position, in accordance with an example embodiment;

FIG. 1(b) illustrates a perspective view of the hay hugger apparatus shown in FIG. 1(b), but in an open position, in accordance with an example embodiment;

FIG. 2 illustrates a pictorial diagram depicting example hay bales with approximately two and three tie hay bale sizes, in accordance with an example embodiment;

FIG. 3 illustrates a pictorial diagram depicting a round hay bale and an approximate round hay bale size;

FIG. 4 illustrates a schematic diagram of a prior art bale guard apparatus;

FIG. 5A illustrates an example of a skid steer loader, which can be adapted for use in accordance with an example embodiment;

FIG. 5B illustrates an example of a skid steer loader, which can be adapted for use in accordance with an example embodiment;

FIG. 6 illustrates a schematic diagram of an offset hydraulic set up arrangement, in accordance with an example embodiment;

FIG. 7 illustrates a schematic diagram of a hay hugger apparatus with a safety factor at an extended length; and

FIG. 8 illustrates a schematic diagram of a hay hugger apparatus with a safety factor at a retracted length.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to identical, like or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Note that the purposes of this disclosure, the term “hay” will be used in a generic sense to describe cut foliage, particularly hay, such as that made from alfalfa, grasses and straw. While this invention is ideally used to handle “hay bales,” this generic term is intended to include any large item, including but not limited to “cargo” in general, bales of cotton, bales of cardboard, or other items such as boxes, pallets, and so on. In other words, the disclosed embodiment are not limited to the agricultural field but can be implemented in other industries and environments requiring lifting machines, such as, for example, warehouses, industrial plants, and so on.

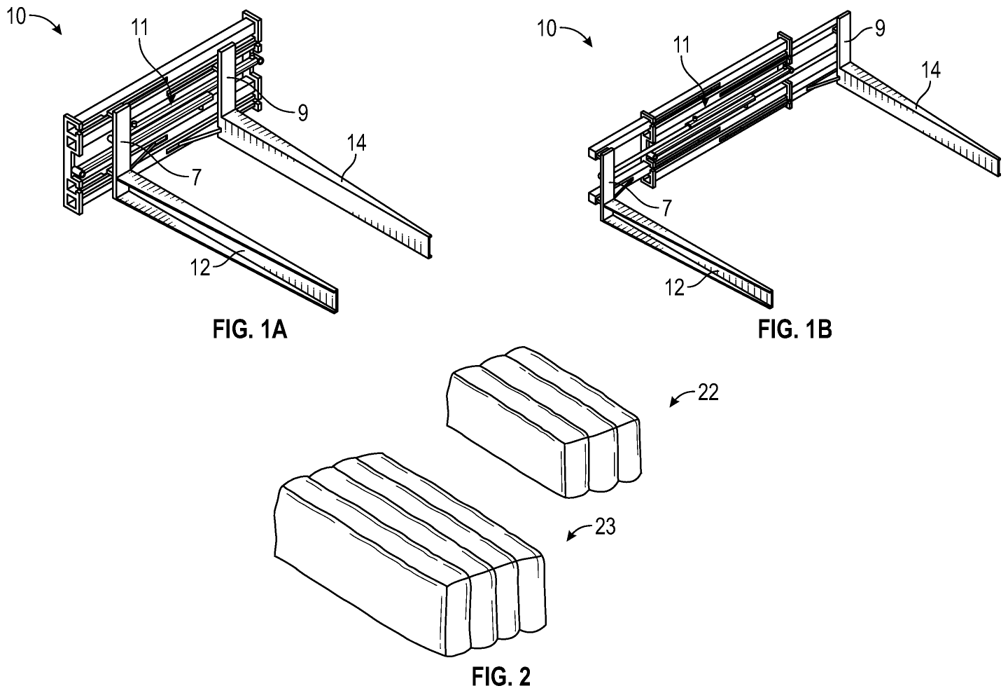

FIG. 1(a) illustrates a pictorial perspective view of a hay hugger apparatus 10 with arms 10 and 12 in a closed position, in accordance with an example embodiment. FIG. 1(b) illustrates a pictorial perspective view of the hay hugger apparatus 10 shown in FIG. 1(b), but the arms 12 and 14 shown in an open position, in accordance with an example embodiment. The hay hugger apparatus 10 includes an offset hydraulic arrangement composed of two hydraulic bars 13 and 15. As will be discussed in greater detail herein, such an offset hydraulic set up arrangement provides additional flexibility and utility for the hay hugger apparatus 10. In the embodiment shown in FIGS. 1(a) and 1(b), the arms 12 and 14 respectively connect to plates 7 and 9, which extend or retract based on the movement of the offset hydraulic arrangement including the two hydraulic bars 13 and 15. Note that similar or identical reference numerals are utilized herein with respect to the various figures to refer to the same or identical part or element.

The hay hugger apparatus 10 (also referred to as a “Hay Hugger”) is an attachment fit for a tractor, skid steer, front-end loader (articulated loader), telehandler and forklift. The hay hugger apparatus 10 is configured to satisfy the needs of a small farm or a local ranch, but can also work well for a large feedlot or dairy. A number of requirements must be met, however, to ensure that the hay hugger apparatus 10 can satisfy these needs. First, the attachment must be universal to the aforementioned machines. The reason that the hay hugger apparatus 10 needs to be able to attach to any machine is that people have different needs and preferences for their machines.

Next, the hay hugger apparatus 10 must be sufficiently adaptable to pick up all sizes and different types of hay. In general the different types of hay are alfalfa, barley, wheat grass, and other types of grass, all of which have different compression ratios and weight ratios. The different types of bales are 2-tie bale, 3-tie bale, round bale, 3×4×8 feet cubed bales, and 3×3×8 feet cubed bale. The weights of these vary depending on how compressed the hay is. The round bale is the heaviest of the hay, usually weighing about 1,100 pounds. The whole group of a 3×4×8 feet cubed bale weighs, for example, approximately 900 pounds, and the 3×3×8 feet cubed is about 800 pounds. The 2-tie and 3-tie are around 50 pounds and 75 pounds, respectively.

In order to accommodate for such a range of bale sizes, the arms 12 and 14 of the attachment (i.e., the hay hugger apparatus 10) should preferably range from a little over 8 feet and compress down to 28 inches. Also, the arms 12 and 14 should be configured in such a manner that the insides and outsides are smooth, and do not include any items or components that protrude out from the arms 12 and 14. This is necessary so that a farmer, for example, can maneuverer a single bale from a grouping of bales. In addition a farmer may need to extend one arm at a time due to space restrictions or the way they desire to move one bale at a time. That being the, a shut off valve should be provided to control each arm 12 and 14 separately. Also, the arms 12 and 14 should be configured so that they will not splay outward due to fatigue from extreme cases. If this were to occur, the user of the hay hugger apparatus 10 would not be able to pick up the single bale. The hydraulics of the hay hugger apparatus 10 must be able to apply approximately 2500-3000 psi. The weight of the entire the hay hugger apparatus 10 should be at most approximately 1900 pounds, depending upon design considerations and applications.

Safety is one of the most important concerns in the design of the hay hugger apparatus 10, particularly because It will be used to load hay into small vehicles or something as large as an 18-wheeler. It can be extremely dangerous to drop a 1100 pound round bale of hay into the back of a pickup or trailer. Therefore, the user must have total control of the hay bale. If they do not, they could easily damage a car or even worse hurt themselves or another person. To accomplish this control, the hydraulics must be able to compress and release slowly. The slow hydraulics help ensure the operator does not accidentally drop the bale and cause damage. The arms of the machine should be long enough to ensure that the user's machine of choice will not have to come within feet of whatever the hay is being loading in. This ensures that no one will run into, for example, a car or a truck with their machine while trying to load/unload hay.

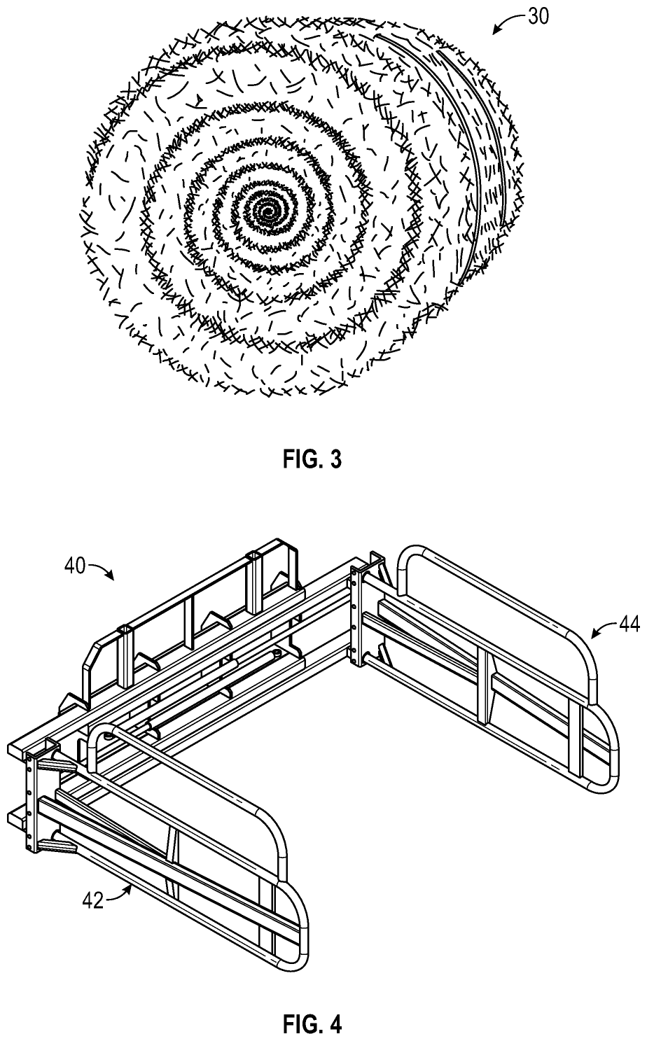

FIG. 3 illustrates a pictorial diagram depicting a round hay bale 30 and an approximate round hay bale size. The round hay bale 30 is shown in FIG. 3 to demonstrates that a hay bale may be configured in a circular or round shape. The hay hugger apparatus 10 can accommodate a variety of hay bale shapes such as, for example, round hay bales such as shown in FIG. 3 or rectangular or square hay bales shapes and so on.

The hay hugger apparatus 10 (also referred to as the “attachment”) can be configured as an attachment that is compatible with skid steers, forklifts, articulated loaders, tractors and telehandlers. The hay hugger apparatus 10 is configured to to pick up hay bales of various sizes, weights, and compositions. The attachment 10 is also configured to close down to 28 inches in order to tightly grip the single bales of hay. Additionally, the hay hugger apparatus 10 is configured to open up wider than 96 inches in order to pick up, for example, a 3×4×8 feet cubed hay bale from its widest side.

In addition the attachment 10 is also be capable of picking up the 3×4×8 feet cubed hay bales along the length of the bale. The hay hugger apparatus 10 can also pick up round bales (e.g., 6 feet in diameter). The round bales are the heaviest of the bales of hay; therefore the weight of the round bale plus the weight of the attachment 10 must not surpass the operating capacity of the limiting machine, in this case, the skid steer.

The hay hugger apparatus 10 can be configured based on the needs of a user (e.g., a customer) to pick up multiple sized bales. In order for this goal to be met, two hydraulics are provided and offset them from each other. This arrangement allows the attachment squeeze in 28 inches and to extend out 100 inches. This allows the user or customer to pick up single bales as well as the 3×4×8 feet cubed bale.

In addition, the hay hugger apparatus 10 does not use round tubing in the arms 12 and 14 to facilitate the amount of permanent displacement. In order to account for this need, the arms 12 and 14 can be designed or configured with a flat steel plate. Gussets can also be used to support the arms 12 and/or 14 and keep the displacement to a minimum. The arms 12 and 14 can also be made to be smooth, which assists the user in separating bales. The hay hugger apparatus 10 is preferably configured with no teeth or sharp edges to meet this need. This is important so that the user can turn, for example, a 3×4×8 feet cubed bale into smaller bales. This also helps facilitate safety, because there are not any spots upon which items may be potentially caught.

Note that in some example embodiments, two shut off valves can be added to hay hugger apparatus 10. This is so that if the user or customer is working against a wall, the user/customer is able to lock one of the arms 12 and/or 14 in place, thereby protecting the attachment 10 and the objects around it. This lets the customer or user utilize all of the space in, for example, a warehouse as well as load hay into trailers.

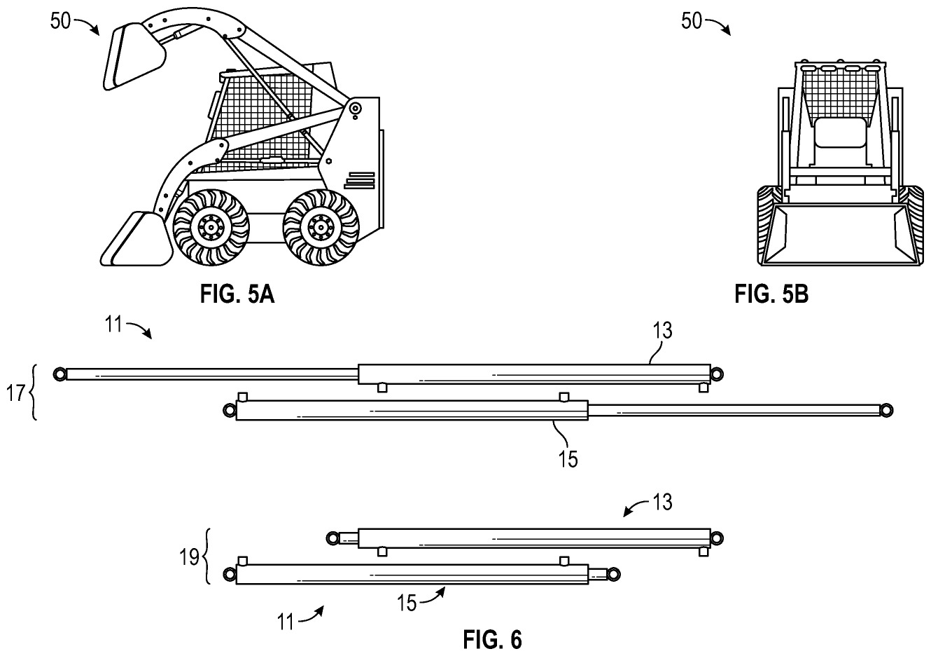

FIGS. 5(a) and 5(b) illustrate an example of a skid steer loader 50, which can be adapted for use in accordance with an example embodiment. FIG. 5(a) shows a side view of the skid steer loader 50 and FIG. 5(b) depicts a front view of the skid steer loader 50. One example of a skid steer loader 50 that can be utilized in accordance with an example embodiment is the New Holland LS190.B Skid Steer Loader. It should be appreciated that the specific New Holland LS190.B Skid Steer Loader is discussed herein for exemplary purposes only and should not be considered a limiting feature of the disclosed embodiments.

Thus, in some situations, a user may plan to operate the hay hugger apparatus 10 with the skid steer loader 50 (e.g., such as a New Holland LS190.B Skid Steer Loader). Although the hay hugger apparatus 10 can work with a multitude of machines, the New Holland device is discussed herein as one example of a skid steer loader, which may be used in some situations. With this in mind, in some situations the operating load rating is 2799.9 pounds, since the max hay bale that will be lifted is 1,100 pounds, and thus the attachment 10 needs to be at most 1,900 pounds. However the weight is a major concern and needs to be cut back wherever possible. The tipping load of this machine is twice as much as the operating load. The hydraulics on this machine also need to be considered, because the relief valve pressure is 3000 psi, and the pump flow capacity is 21.9 gal/min. These concerns were all met with the design at hand. By the end of the iterative process the attachment is around 780 pounds, which does not include the hydraulic fluid.

It is desirable for the hay hugger apparatus/attachment 10 to function effectively with different machines including, for example, articulated loaders, forklifts, tractors, skid loaders, and telehandlers. In order to accommodate this goal, the attachment back can be configured in some embodiments to be flat. Thus, in a commercial situation the attachment plate could be purchased for the desired machine, which may be welded to the attachment. In other words, a skid steer attachment 10 could be purchased and attached. By configuring the design of some embodiments to such specifications, the field of application of the apparatus 10 is broadened significantly. Thus, apparatus/attachment 10 is not limited to only farming applications such as loading and unloading bales of hay, but can be utilized in other situations such as in grocery stores, “big box” stores and so on where various types of fork lifts and lifting devices are utilized.

The concept of the hay hugger apparatus 10 is based on two primary parameters. The design of the apparatus 10 must ensure that the apparatus 10 is capable of lifting a wide range different hay bales with two limiting factors being a small 2-tie square hay bale, and a large round hay bale (e.g., see the round hay bale 30 shown in FIG. 3). The versatility of the design of the apparatus 10 allows a user to retract and expand the arms from, for example, 28 to 100 inches.

With these two limiting factors in mind, the first order of business in designing an embodiment of apparatus 10 involves finding hydraulic cylinders that can achieve such example desired lengths. With a retracted length of, for example, 44 inches and a stroke of 36 inches, a hydraulic can be implemented, which will allow a hay hugger apparatus embodiment to meet such desired requirements.

FIG. 6 illustrates a schematic diagram of an offset hydraulic set up arrangement 11 shown in an extended position 17 and a retracted position 11, in accordance with an example embodiment. FIG. 6 illustrates different formations that can be implemented for an offset hydraulic set up arrangement with hydraulic bars 13 and 15.

Once the hydraulics are satisfied, a main focus of the design of the hay hugger apparatus shifts to the design of the arms 12 and 14 to ensure that they are capable of withstanding different loads that will be applied. With a 3×4×8 feet cubed stack of square bales in mind, for example, the arms 12 and 14 must be at least 5.5 feet to grab each bale on the bottom of the stack.

Knowing these limitations, design iterations can be implemented for the arms 12 and 14 to ensure that the different loads will not result in failure at any point. The different loads range from an estimated 1500 pounds round bale to a stack of square bales weighing about 1100 pounds. Ultimately, a final iteration may be a thin, solid, lightweight arm design that results in the highest safety factor and with the least amount of deflection possible at the end of the arms 12 and/or 14. With this design, the only material needed for the structure of the hay hugger apparatus 10 is mild steel. This is optimal as mild steel is readily available and can decrease the overall cost of acquiring all the material. It should be appreciated, however, that the use of steel as discussed above is not a limiting feature of the disclosed embodiments. Other types of materials may be utilized in place of steel, depending on the design considerations and potential applications of the hay hugger apparatus 10.

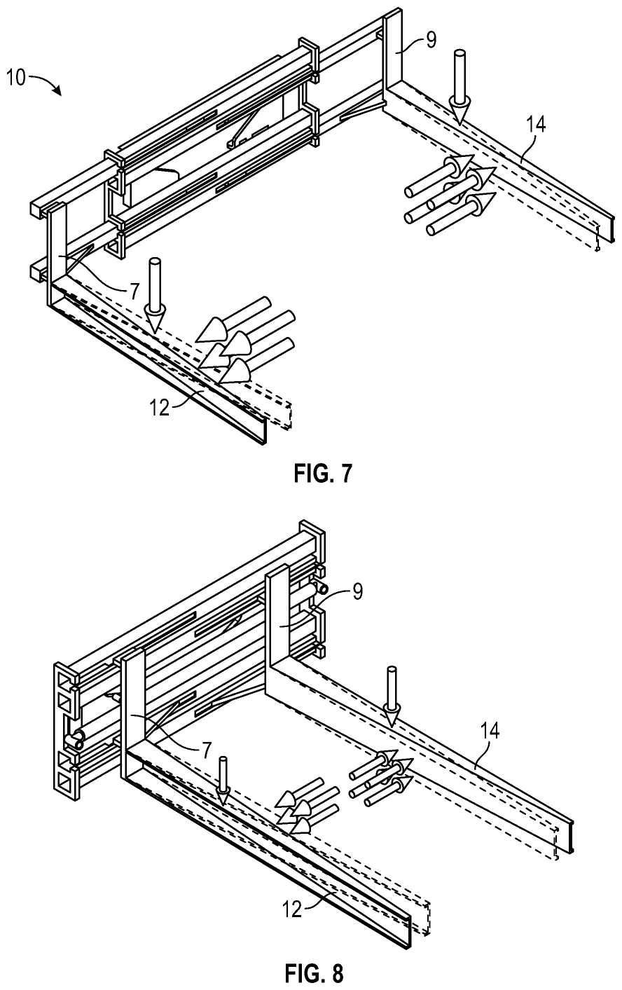

FIG. 7 illustrates a schematic diagram of a hay hugger apparatus 10 with a safety factor at an extended length. FIG. 8 illustrates a schematic diagram of the hay hugger apparatus 10 with a safety factor at a retracted length.

Since the prior art apparatus 40 shown in FIG. 4 (i.e., “The Squeeze”) experiences major deflection in its arms, a main point of concern for the design of the hay hugger apparatus 10 lies in issues of deflection as well. In one embodiment, a solid steel plate with two reinforcing arm gussets can be used to counteract the large bending stress where the arms would grip the hay, thus solving the deflection problem of other “squeezes”. Upon utilization of this design, the consequence is a large movement at the attachment of the arm to the male booms. The arm back plate (e.g., plates 7 and 9) attaches the arm plate and arm gussets to the key. The parts joining the male booms and arm plate is called the key and key gusset. The key is located on the upper male boom of the arm back plate and the key gusset can be found on the lower male boom. The larger moment on the lower key gusset calls for a more robust design such that the stress will flow through the male boom rather than being concentrated at the welds on the key; this is the reason for the gusset on the lower key.

The large bending moment was then translated to the male boom, which now undergoes a large bending stress. This moment is then translated to the support end piece where it transfers to the female boom. With the large bending moments on the hay hugger apparatus 10, there are risks involved with failure. ANSYS can be used to determine where the hay hugger apparatus 10 may fail. Throughout the design, mild steel material can be used with a yield strength of, for example, 48 ksi and tensile strength of 66 ksi. An inspection of an ANSYS analysis report shows that the maximum stress will be applied to the female boom as the hay hugger apparatus 10 is at its fully extended length of 100 inches. The largest bending moment occurs as it squeezes the highest risk bale size of 3×4×8 feet cubed. A bale of this size has an average weight of around 900 pounds so the bale weight was exaggerated to be 1200 pounds. With this specific and example non-limiting case, the lowest safety factor associated with an extended length of 100 inches is 1.67 on the junction of the right support end piece and the female boom. If the arms 12 and/or 14 were to fail, the failure would be gradual with no sudden fracture and there would be little to no risk of injury. If the pressure relief valve were to be tampered with or malfunction, the female boom has the potential to bend due to an increased load applied to the arms. Again, this will be cause little to no risk of injury due to a gradual deformation.

The hay hugger apparatus 10 might fail where the safety factor is close to that of the minimum safety factor. Such places would be the welds at the keys or the male boom. In the case that the keys fail, the arm may fracture suddenly causing potential risk of injury to the operator or anyone in the vicinity due to the arm detaching. If the male boom were to bend, it would do so gradually with no sudden fracture.

With the hay hugger apparatus 10 at its fully retracted length, the minimum safety factor is higher than that of the fully extended length at, for example, 2.22. If the pressure relief valve were to be tampered with or malfunction allowing for more pressure, the force applied to the hay would increase and could potentially overload the arms. The expectation in such a case is that the female boom would bend due to a higher moment, causing the arms to no longer extend and contract. The failure would be gradual and no sudden fracture would occur causing little risk to injury.

The hay hugger apparatus 10 can be preferably equipped with a warning sign that indicates to an operator or user the limits of the apparatus 10. These limits may include the maximum load the machine can lift and the range of the hydraulics. These warnings can help ensure that the operator of the machine is aware of the limits and does not try and pick up anything too heavy and ruin the machine, and come to terms with the size of an object the operator can lift safely. In some embodiments, the arms 12 and 14 of the hay hugger apparatus 10 may be configured to extend passed 8 feet so the user/operator should be aware of the surroundings so that that the machine is not damaged while it is in operation. Another feature that can be considered in the configuration of the hay hugger apparatus 10 is painting the tips of the arms with a bright color (e.g., yellow, orange, red) so that the operator or anyone in the surrounding area can clearly see the arms if they are in range of the machine.

The hay hugger apparatus 10 should following some specific hydraulic safety guidelines. For example, all hydraulic hoses, tube lines and fittings should be periodically inspected. Any deterioration must be carefully examined to determine whether further use of the component would constitute a hazard.

Conditions such as the following should be sufficient for consideration of replacement. For example, such conditions may include any evidence of hydraulic oil leakage at the surface of a flexible hose or its junction with the metal and couplings; any blistering or abnormal deformation to the outer covering of a hydraulic hose; hydraulic oil leakage at any threaded or clamped joint that cannot be eliminated by normal tightening or recommended procedures; and/or evidence of excessive abrasion or scrubbing on the outer surface of a hose, rigid tube, or hydraulic fitting. Modifications can be made to eliminate the interference of the elements in contact, or otherwise protect the components.

Based on the foregoing, it can be appreciated that a number of example embodiments (including preferred and alternative embodiments) are disclosed herein. For example, in one embodiment, a hugger apparatus for lifting a load can be implemented. Such an apparatus can include a plurality of arms including a first arm and a second arm respectively attached to a first plate and a second plate, and an offset hydraulic arrangement that includes first and second hydraulic bars. The offset hydraulic arrangement connects to and engages said first plate and second plate so as to respectively move said first and second arms into extended or retracted positions for engaging with and lifting and moving loads of a variety of shapes and sizes.

In some example embodiments, the aforementioned offset hydraulic arrangement can be configured to include a female boom that maintains said first and second hydraulic bars. In another example embodiment, an attachment plates can be provided, which connects to said female boom and which allows said hugger apparatus to attach to an external lifting machine. In yet another example embodiment, at [[at]] least one male boom can be provided, which engages said female boom.

In still another example embodiment each of the first and second plates can comprise arm plates that include a respective arm plate gusset. In another example embodiment, the respective arm plate gusset(s) can be configured to include a reinforcing gusset(s) that transfers bending momentum away from the first and second arms to avoid deflection of the first or second arms. In another example embodiment, the aforementioned load can be, for example, a hay bale, or another type of load such as a crate, a box, a pallet, and so on.

In addition, petroleum based hydraulic fluids are widely used. Hydraulic oil becomes hot during operations. A heated petroleum based hydraulic fluid presents a considerable fire hazard, particularly in those processes where ignition sources are usually present. A typical petroleum based hydraulic fluid has a flash point that ranges from 300 to 600 degrees Fahrenheit and an auto ignition temperature with a range of 500 to 750 degrees Fahrenheit. However, when hydraulic fluid is accidentally discharged under high pressure an easily ignited fine oil mist is sprayed over the surrounding area. When the mist reaches an ignition source the result can be a torch-like ball of fire. If the oil mist is confined, a violent explosion can occur.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

What is claimed is:

1. An apparatus for lifting a load, said apparatus comprising:
a plurality of arms including a first arm and a second arm respectively attached to a first plate and a second plate;
an offset hydraulic arrangement that includes first and second hydraulic bars, wherein said offset hydraulic arrangement connects to and engages said first plate and second plate so as to respectively move said first and second arms into extended or retracted positions for engaging with and lifting and moving loads of a variety of shapes and sizes.

2. The apparatus of claim 1 wherein said offset hydraulic arrangement includes a female boom that maintains said first and second hydraulic bars.

3. The apparatus of claim 2 further comprising an attachment plates that connects to said female boom and which allows said hugger apparatus to attach to an external lifting machine.

4. The apparatus of claim 2 further comprising at least one male boom that engages said female boom.

5. The apparatus of claim 1 wherein said each of said first and second plates comprises arm plates that include a respective arm plate gusset.

6. The apparatus of claim 5 wherein said respective arm plate gusset comprises a reinforcing gusset that transfers bending momentum away from said first and second arms to avoid deflection of said first or second arms.

7. The apparatus of claim 1 wherein said load comprises a hay bale.

8. An apparatus for lifting a load, comprising:
a plurality of arms including a first arm and a second arm respectively attached to a first plate and a second plate;
an offset hydraulic arrangement that includes first and second hydraulic bars, wherein said offset hydraulic arrangement connects to and engages said first plate and second plate so as to respectively move said first and second arms into extended or retracted positions for engaging with and lifting and moving loads of a variety of shapes and sizes, wherein said offset hydraulic arrangement includes a female boom that maintains said first and second hydraulic bars.

9. The apparatus of claim 8 further comprising an attachment plates that connects to said female boom and which allows said hugger apparatus to attach to an external lifting machine.

10. The apparatus of claim 8 further comprising at least one male boom that engages said female boom.

11. The apparatus of claim 8 wherein said each of said first and second plates comprises arm plates that include a respective arm plate gusset.

12. The apparatus of claim 11 wherein said respective arm plate gusset comprises a reinforcing gusset that transfers bending momentum away from said first and second arms to avoid deflection of said first or second arms.

13. The apparatus of claim 8 wherein said load comprises a hay bale.

14. The apparatus of claim 8 further comprising:
an attachment plates that connects to said female boom and which allows said hugger apparatus to attach to an external lifting machine; and
at least one male boom that engages said female boom.

15. The apparatus of claim 14 wherein said each of said first and second plates comprises arm plates that include a respective arm plate gusset.

16. The apparatus of claim 15 wherein said respective arm plate gusset comprises a reinforcing gusset that transfers bending momentum away from said first and second arms to avoid deflection of said first or second arms.

17. The apparatus of claim 14 wherein said each of said first and second plates comprises arm plates that include a respective arm plate gusset.

18. The apparatus of claim 17 wherein said respective arm plate gusset comprises a reinforcing gusset that transfers bending momentum away from said first and second arms to avoid deflection of said first or second arms.

19. An apparatus for lifting a load, said apparatus comprising:
a plurality of arms including a first arm and a second arm respectively attached to a first plate and a second plate;
an offset hydraulic arrangement that includes first and second hydraulic bars, wherein said offset hydraulic arrangement connects to and engages said first plate and second plate so as to respectively move said first and second arms into extended or retracted positions for engaging with and lifting and moving loads of a variety of shapes and sizes, wherein said offset hydraulic arrangement includes a female boom that maintains said first and second hydraulic bars; and
an attachment plates that connects to said female boom and which allows said hugger apparatus to attach to an external lifting machine.

20. The apparatus of claim 19 further comprising at least one male boom that engages said female boom, wherein said each of said first and second plates comprises arm plates that include a respective arm plate gusset, and wherein said respective arm plate gusset comprises a reinforcing gusset that transfers bending momentum away from said first and second arms to avoid deflection of said first or second arms.
